(19) United States
(12) Patent Application Publication
(10) Pub. No.: US 2016/0067661 A1
(43) Pub. Date: Mar. 10, 2016

(54) Benzyl Alcohol Alkoxylates As Solubilizers For Aqueous Surfactant Solutions

(71) Applicant: CLARIANT INTERNATIONAL LTD., Muttenz (CH)

(72) Inventor: Hendrik AHRENS, Kriftel (DE)

(73) Assignee: CLARIANT INTERNATIONAL LTD., Muttenz (CH)

(21) Appl. No.: 14/786,086

(22) PCT Filed: Apr. 10, 2014
(86) PCT No.: PCT/EP2014/000967

§ 371 Date: Oct. 21, 2015

(30) Foreign Application Priority Data
Apr. 24, 2013 (DE) 10 2013 007 177.1

(51) Int. Cl. B01F 17/00; C08F 2/30

(52) U.S. Cl. CPC B01F 17/0092; C08F 2/30

(57) ABSTRACT

The invention relates to aqueous surfactant solutions containing (A) 50.0 to 90.0% by weight of an ethoxylate of linear saturated or unsaturated fatty alcohols of formula (I),

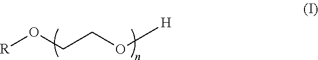

wherein R is a linear alkyl- or alkenyl group having 6 to 22 carbon atoms, n is an integer from 3 to 100, (B) 0.01 to 20.0% by weight of a benzyl alcohol alkoxylate of formula (II),

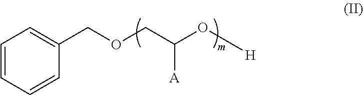

wherein A is a hydrogen atom or a methyl group, m is a number from 3 to 10, and (C) water.

The present invention relates to aqueous surfactant solutions comprising benzyl alcohol alkoxylates, and also use thereof as emulsifiers for emulsion polymerization.

Fatty alcohol ethoxylates are prepared according to the prior art by addition of ethylene oxide to natural and synthetic fatty alcohols having a carbon chain length of 8 to 22 carbon atoms. Typical fatty alcohols for ethoxylation are fatty alcohols of natural origin such as decyl alcohol, lauryl alcohol, cetyl alcohol, myristyl alcohol, oleyl alcohol, stearyl alcohol, or mixtures of C₈- to C₂₂-chain segments such as coconut fatty alcohol and palm kernel oil alcohol. Furthermore, synthetic primary alcohols such as iso-C₁₃-oxo alcohols, C₁₃/C₁₅-oxo alcohols, mixtures of linear, mono-branched or poly-branched oxo alcohols having an average carbon chain length of 10 to 15 carbon atoms, Ziegler alcohols having 8 to 22 carbon atoms and Guerbet alcohols having 10, 12, 14, 16 or 18 carbon atoms and linear and branched secondary alkanols having 8 to 22 carbon atoms are suitable. The alcohols used may be in saturated and unsaturated form. It is observed that the melting point of the ethoxylates increases with increasing degree of ethoxylation, tending to a limit of about 60° C. in highly ethoxylated fatty alcohol ethoxylates. It can be further observed that ethoxylates of branched fatty alcohols show a lower melting temperature than ethoxylates of natural, linear, saturated fatty alcohols.

In order to provide a liquid product for transport and metered addition in the particular application, the fatty alcohol ethoxylates are mixed with solvents such as water and organic solvents and also further melting point lowering substances. Water is typically used as solvent. Aqueous solutions of ethoxylates of natural, linear, saturated or unsaturated fatty alcohols are fixed, however, in a concentration range of >30% by weight and in particular cases at 35% by weight to 100% by weight of fatty alcohol ethoxylate in water at a room temperature of 25° C.

Thus, the prior art describes the addition of organic solvents and solubilizers in order to keep aqueous solutions of fatty alcohol ethoxylates fluid.

EP-1251736 describes surfactant/solvent combinations of alcohols, diols and alkoxylated alcohols.

U.S. Pat. No. 5,346,973 describes pourable, liquid surfactant concentrates comprising 50 to 90% by weight of surfactant mixture of saturated or unsaturated fatty alcohol ethoxylates having 6 to 22 carbon atoms and alkanediol ethoxylates as solubilizers in water.

US-2002076426A1 describes terpene alcohol ethoxylates as solvents for cosmetic and pharmaceutical preparations.

US-2010041577 describes highly concentrated, liquid detergent concentrates comprising glycols, polyglycols, glycol ethers or benzyl alcohol as solvents.

WO-2005017047 describes polyethylene glycols as solvents and humectants for pigment preparations comprising surfactant mixtures.

A disadvantage of known organic solvents is their low boiling point which is often <250° C. Organic compounds with a boiling point of <250° C. are classified as volatile organic compounds (VOC) according to EU Directive 2004/42/EG and considered environmentally hazardous.

A further disadvantage of known organic solvents is their ecological and toxicological behavior. Numerous solvents are toxic, irritating to skin and mucous membranes, poorly biologically degradable and environmentally harmful.

A disadvantage of polyethylene glycols and polyalkylene glycols is their hygroscopic behavior. For this reason, polyethylene glycols and polyalkylene glycols are used as humectants and water-retaining agents as described in WO-2005017047.

A further disadvantage of known solubilizers is their poor availability and high production costs. The alkanediol ethoxyaltes described in U.S. Pat. No. 5,346,973 are prepared by oxidation of alpha-olefins to the epoxide, subsequent hydrolysis to the 1,2-alkanediols and ethoxylation and are only poorly available due to the complex, multistage synthesis.

It was therefore an object of the present invention to find novel solvents with a boiling point of <250° C. , which lower the melting point or the melting range of aqueous solutions of ethoxylates of linear, saturated or unsaturated fatty alcohols to below room temperature of 25° C. and do not have the above disadvantages.

It has been found, surprisingly, that benzyl alcohol alkoylates achieve this object.

The invention therefore provides aqueous surfactant solutions comprising
(A) 50.0 to 90.0% by weight of an ethoxylate of linear, saturated or unsaturated fatty alcohols of the formula (I),

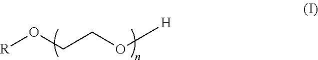

in which
   R is a linear, alkyl or alkenyl residue having 6 to 22 carbon atoms,
   n is an integer from 3 to 100,
(B) 0.01 to 20.0% by weight of a benzyl alcohol alkoxylate of the formula (II),

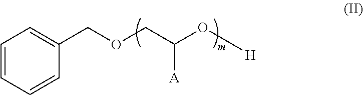

in which
   A is a hydrogen atom or a methyl group,
   m is a number from 3 to 10, and
(C) water.

The aqueous surfactant solutions according to the invention may also comprise customary by-products of alkoxylation reactions. Customary by-products of the alkoxylation reaction are low traces of diethylene glycol, polyethylene glycols, propylene glycol, dipropylene glycol, polypropylene glycols and mixed polymers of ethylene glycol and propylene glycol, also catalyst residues such as sodium, potassium or calcium salts. Typical sodium, potassium or calcium salts are the salts of acetic acid, propionic acid, lactic acid or higher carboxylic acids such as isononanoic acid. The aqueous surfactant solutions according to the invention may furthermore comprise unreacted starting alcohols. These include unreacted fatty alcohols having 6 to 22 carbon atoms and unreacted benzyl alcohol. The content of such by-products and unreacted starting alcohols is typically <1% by weight, based on the aqueous surfactant solution. The term “higher carboxylic acid” was understood to mean carboxylic acid having 6 to 18 carbon atoms. An example of this is isononanoic acid.

Component (A) is an ethoxylate of linear, saturated or unsaturated fatty alcohols having 6 to 22, preferably 12 to 18 carbon atoms and mixtures thereof. Suitable fatty alcohols are hexan-1-ol, octan-1-ol, decan-1-ol, lauryl alcohol, myristyl alcohol, cetyl alcohol, stearyl alcohol, eicosanol, behenyl alcohol, hexadecenol, oleyl alcohol and linoleyl alcohol. The ethoxylates are present as a homologous series having an average degree of ethoxylation. The average degree of ethoxylation of component (A) is 3 to 100, preferably 5 to 80 and particularly preferably 8 to 50.

Component (B) is a benzyl alcohol alkoxylate, prepared by alkoxylation of benzyl alcohol with ethylene oxide and/or propylene oxide. The benzyl alcohol alkoxylate can be present both as an ethoxylate, propoxylate or as a mixed alkoxylate of ethylene oxide and propylene oxide, in which ethylene oxide and propylene oxide may be added in blocks or randomly to the benzyl alcohol. The alkoxylation is carried out by anionic, acidic- or alkaline-catalzyed addition of ethylene oxide and/or propylene oxide, wherein the mean degree of alkoxylation is 3 to 10, preferably 4 to 8.

In a preferred embodiment, the water content of the aqueous surfactant solution according to the invention is made up to 100% by weight.

The aqueous surfactant solutions according to the invention are transparent liquids of low viscosity at a room temperature of 25° C. and can be easily dispensed or conveyed by means of pumps. Furthermore, the aqueous surfactant solutions according to the invention can be simply further diluted with water.

The invention further provides a method for emulsion polymerization by reacting 1.0 to 70.0% by weight of at least one olefinically unsaturated monomer by means of free radical polymerization in the presence of 0.01 to 5.0% by weight of the aqueous surfactant solution according to the invention and optionally 0 to 5.0% by weight of an anionic surfactant.

The invention further relates to the use of 0.01 to 5.0% by weight of the aqueous surfactant solution according to the invention and optionally 0 to 5.0% by weight of an anionic surfactant as emulsifier in the free radical emulsion polymerization of olefinically unsaturated monomers.

The percentages by weight values in the method and use refer to the weight of the reaction mixture capable of emulsion polymerization.

Olefinically unsaturated monomers are understood to mean compounds comprising one or more, preferably one, olefinic double bond, and which are amenable to free radical polymerization. Preferred olefinically unsaturated monomers are
vinyl monomers, such as carboxylic esters of vinyl alcohols, for example, vinyl acetate, vinyl propionate, vinyl ethers of isononanoic acid or isodecanoic acid, which are also referred to as C₉ and C₁₀-versatic acids,
aryl substituted olefins, such as styrene and stilbene,
olefinically unsaturated carboxylic esters, such as methyl acrylate, ethyl acrylate, propyl acrylate, n-butyl acrylate, i-butyl acrylate, pentyl acrylate, hexyl acrylate, 2-ethylhexyl acrylate, tridecyl acrylate, stearyl acrylate, hydroxyethyl acrylate, hydroxypropyl acrylate and the corresponding methacrylates,
olefinically unsaturated dicarboxylic esters, such as dimethyl maleate, diethyl maleate, dipropyl maleate, dibutyl maleate, dipentyl maleate, dihexyl maleate and di-2-ethylhexyl maleate,
olefinically unsaturated carboxylic acids and dicarboxylic acids, such as acrylic acid, methacrylic acid, itaconic acid, maleic acid and fumaric acid and sodium, potassium and ammonium salts thereof,
olefinically unsaturated sulfonic acids and phosphonic acids and alkali metal and ammonium salts thereof, such as vinylsulfonic acid, vinylphosphonic acid, acrylamidomethylpropanesulfonic acid and alkali metal and ammonium, alkylammonium and hydroxyalkylammonium salts thereof, allylsulfonic acid and alkali metal and ammonium salts thereof, acryloyloxethylphosphonic acid and ammonium and alkali metal salts thereof and also the corresponding methacrylic acid derivatives,
olefinically unsaturated amines, ammonium salts, nitriles and amides, such as dimethylaminoethyl acrylate, acryloyloxethyltrimethylammonium halides, acrylonitrile, acrylamide, methacrylamide, N-methylacrylamide, N-ethylacrylamide, N-propylacrylamide, N-methylolacrylamide and also the corresponding methacrylic acid derivatives and vinylmethylacetamide.

In a preferred embodiment, the monomers mentioned above are polymerized with further comonomers, preferably olefins or halogenated olefins having 2 to 8 carbon atoms, such as ethylene, propene, butenes, pentenes, 1,3-butadiene, chloroprene, vinyl chloride, vinylidene chloride, vinylidene fluoride and tetrafluoroethylene.

### EXAMPLES 1 - 13 (COMPARATIVE EXAMPLES) AND EXAMPLES 14 - 16

### Surfactant Solutions

Melting point of aqueous solutions of a linear, saturated C₁₂/C₁₄-fatty alcohol ethoxylate having 30 mol of ethylene oxide

### Solubilizers

| | |
|---|---|
| PEG 1000 | polyethylene glycol having a molecular weight of |
| | 1000 g/mol (comparative example) |
| PEG 4000 | polyethylene glycol having a molecular weight of |
| | 4000 g/mol (comparative example) |
| Dodecanediol + 8 EO | 1,2-dodecanediol reacted with 8 mol of |
| | ethylene oxide (comparative example) |
| Polyglycol P 31/300 | pentaerythritol mixed alkoxylate having a molar |
| | ratio of ethylene oxide to propylene oxide |
| | of 4:1 and a mean molecular weight of |
| | ca. 5000 g/mol (comparative example) |
| Genapol BA 040 | benzyl alcohol reacted with 4 mol of ethylene |
| | oxide having a content of readily volatile |
| | compounds, particularly unreacted benzyl alcohol, |
| | of <1% |

TABLE 1

| Example | 1 | 2 | 3 | 4 |
|---|---|---|---|---|
| Fatty alcohol ethoxylate [%] | 65 | 60 | 55 | 50 |
| PEG 1000 [%] | 0 | 5 | 10 | 15 |
| Water [%] | 35 | 35 | 35 | 35 |
| Total [%] | 100 | 100 | 100 | 100 |
| Melting point [° C.] | 30 | 25 | 15 | 10 |
| Brookfield viscosity | n.d. | n.d. | 1635 | 920 |
| at 25° C. [mPas] | | | | |

n.d. not determined

TABLE 2

| | Example | | | | | |
|---|---|---|---|---|---|---|
| | 5 | 6 | 7 | 8 | 9 | 10 |
| Fatty alcohol ethoxylate | 60 | 55 | 50 | 60 | 55 | 50 |
| [%] | | | | | | |
| PEG 4000 [%] | 5 | 10 | 15 | — | — | — |
| Dodecanediol + 8 EO [%] | — | — | — | 5 | 10 | 15 |
| Water [%] | 35 | 35 | 35 | 35 | 35 | 35 |
| Total [%] | 100 | 100 | 100 | 100 | 100 | 100 |
| Melting point [° C.] | 15 | 10 | 10 | 20 | 10 | 6 |
| Brookfield viscosity | 2125 | 1390 | 1320 | 3050 | 860 | 515 |
| at 25° C. [mPas] | | | | | | |

TABLE 3

| | Example | | | | | |
|---|---|---|---|---|---|---|
| | 11 | 12 | 13 | 14 | 15 | 16 |
| Fatty alcohol ethoxylate | 60 | 55 | 50 | 60 | 55 | 50 |
| [%] | | | | | | |
| Polyglycol P31/300 [%] | 5 | 10 | 15 | — | — | — |
| Genapol BA 040 [%] | — | — | — | 5 | 10 | 15 |
| Water [%] | 35 | 35 | 35 | 35 | 35 | 35 |
| Total [%] | 100 | 100 | 100 | 100 | 100 | 100 |
| Melting point [° C.] | 20 | 10 | 10 | 20 | 8 | 6 |
| Brookfield viscosity | 2800 | 1264 | 920 | 1480 | 1333 | 355 |
| at 25° C. [mPas] | | | | | | |

### EXAMPLE 17

Emulsion polymerization
1060 g of a monomer emulsion consisting of the following components are prepared by adding with stirring to a glass vessel.

| | |
|---|---|
| 215.4 g | demineralized water, |
| 25.0 g | of a 27% solution of an alkyl polyethylene glycol ether sulfate, |
| | sodium salt having 7 ethylene oxide units (Emulsogen ® EPA |
| | 073, from Clariant), |
| 32.1 g | of the inventive, aqueous surfactant solution from Example 15, |
| 7.5 g | acrylic acid (monomer), |
| 15.0 g | methacrylic acid (monomer), |
| 15.0 g | methacrylamide (monomer), |
| 412.0 g | 2-ethylhexyl acrylate (monomer), |
| 338.0 g | styrene (monomer). |

In parallel, an initiator solution is prepared consisting of 2.6 g of ammonium peroxodisulfate and 71.7 g of demineralized water. The following components are charged in a 2 liter reaction vessel:

| | |
|---|---|
| 374.0 g | demineralized water and |
| 2.8 g | of a 27% solution of an alkyl polyethylene glycol ether sulfate, |
| | sodium salt having 7 ethylene oxide units (Emulsogen ® EPA |
| | 073, from Clariant). |

The emulsifier solution is heated to 80° C. in the reaction vessel and 23.0 g of the monomer emulsion and 14.9 g of the initiator solution are added under a nitrogen atmosphere and while stirring with an anchor stirrer. As soon as the free radical polymerization reaction begins, the temperature of the reaction mixture increases and the heat of reaction is removed by cooling the reaction vessel. The remaining monomer emulsion and 29.7 g of initiator solution are added at 80° C. over a period of 3 hours. Subsequently, a further 29.7 g of initiator solution are added and the mixture stirred at 80° C. for 1 hour. The resulting aqueous polymer dispersion is cooled to 60° C., 21.4 g of a 7% tert-butyl hydroperoxide solution are added and the mixture stirred at 60° C. for a further hour in order to completely polymerize unreacted monomers as far as possible. For the same reason, 30.0 g of a 5% sodium metabisulfite solution are then added and the mixture stirred at 60° C. for a further hour. The aqueous polymer dispersion is then cooled and the pH adjusted to 7-8 with 37.5 g of a 10% sodium hydroxide solution.

The polymer dispersion is a stable, milky liquid with the following properties:

| Test | Result | |
|---|---|---|
| Solids content | 50.1% | by weight |
| Coagulum | 312 | ppm |
| Particle size | 144 | nm |
| Viscosity | 1066 | mPas |

| | |
|---|---|
| Freeze-thaw stability | Stable after 5 cycles |
| Storage stability test | Stable |
| Electrolyte resistance | Stable |

1. An aqueous surfactant solution comprising
(A) 50.0 to 90.0% by weight of an ethoxylate of linear, saturated or unsaturated fatty alcohols of the formula (I), 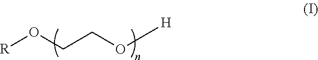
in which
R is a linear, alkyl or alkenyl residue having 6 to 22 carbon atoms,
n is an integer from 3 to 100,
(B) 0.01 to 20.0% by weight of a benzyl alcohol alkoxylate of the formula (II), 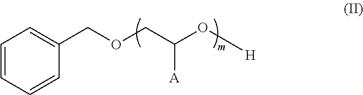
in which
A is a hydrogen atom or a methyl group,
m is a number from 3 to 10, and
(C) water.

2. The aqueous surfactant solution as claimed in claim 1, comprising further customary by-products selected from the group consisting of the following components: diethylene glycol, polyethylene glycols, propylene glycol, dipropylene glycol, polypropylene glycols, mixed polymers of ethylene glycol and propylene glycol, sodium, potassium or calcium salts of acetic acid, propionic acid, lactic acid and higher carboxylic acids.

3. The aqueous surfactant solution as claimed in claim 1, wherein the proportion of water is made up to 100% by weight.

4. The aqueous surfactant solution as claimed in claim 1, wherein n is a number from 8 to 50.

5. The aqueous surfactant solution as claimed in claim 1, wherein R is an alkyl or alkenyl residue having 12 to 18 carbon atoms.

6. The aqueous surfactant solution as claimed in claim 1, wherein A is hydrogen.

7. The aqueous surfactant solution as claimed in claim 1, wherein m is 4 to 8.

8. A method for preparing a polymer emulsion by reacting at least one olefinically unsaturated monomer by free radical polymerization in the presence of 0.01 to 5% by weight of an aqueous surfactant solution based on the weight of the reaction mixture, wherein the aqueous surfactant solution comprises
(A) 50.0 to 90.0% by weight of an ethoxylate of linear, saturated or unsaturated fatty alcohols of the formula (I), 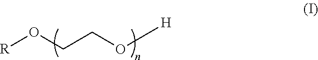
in which
R is a linear, alkyl or alkenyl residue having 6 to 22 carbon atoms
n is an integer from 3 to 100,
(B) 0.01 to 20.0% by weight of a benzyl alcohol alkoxylate of the formula (II), 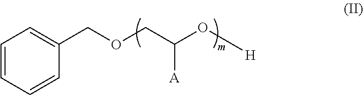
in which
A is a hydrogen atom or a methyl group,
m is a number from 3 to 10, and
(C) water.

9. The method as claimed in claim 8, wherein the amount of the at least one olefinically unsaturated monomer is between 1 and 70% by weight, based on the weight of the reaction mixture.

10. The method as claimed in claim 8, wherein additionally up to 5% by weight of an anionic surfactant is present.

11. The method as claimed in claim 1, wherein the olefinically unsaturated monomers are selected from the group consisting of vinyl monomers, aryl-substituted olefins, olefinically unsaturated carboxylic esters, olefinically unsaturated dicarboxylic esters, olefinically unsaturated carboxylic acids and dicarboxylic acids, and sodium, potassium and ammonium salts thereof, olefinically unsaturated sulfonic acids and phosphonic acids and alkali metal and ammonium salts thereof, olefinically unsaturated amines, ammonium salts, nitriles and amides, and vinylmethylacetamide.

12. An emulsifier in the free radical emulsion polymerization of olefinically unsaturated monomers comprising 0.01 to 5.0% by weight of the aqueous surfactant solution as claimed in claim 1, and optionally 0 to 5.0% by weight of an anionic surfactant.
